(19) United States
(12) Patent Application Publication
(10) Pub. No.: US 2003/0154419 A1
(43) Pub. Date: Aug. 14, 2003

(54) Register renaming in binary translation using rollback and recovery

(76) Inventors: Binyu Zang, Shanghai (CN); Yun Wang, Shanghai (CN); Orna Etzion, Haifa (IL)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/043,496

(22) Filed: Jan. 10, 2002

(51) Int. Cl. H02H 3/05

(52) U.S. Cl. 714/2

(57) ABSTRACT

In one embodiment of the invention, a first last use of a first canonical register in a block of code is recorded after a renaming. The first canonical register is mapped to a first original register. One of a first rollback and a first recovery is applied to the first original register based on whether the recorded first last use occurs before a first last definition of the first original register in the block of code.

### BACKGROUND

1. Field of the Invention

This invention relates to microprocessor compilers. In particular, the invention relates to register renaming.

2. Description of Related Art

Binary translation is a process to translate a source binary code for a source architecture into a translated code to be run on a target architecture. Typically, the number of registers in the source architecture is much less than that in the target architecture. When the large register set in the target architecture can be exploited, the translated code may have improved performance. The renaming of the registers take advantage of the large register set. One problem in the renaming mechanism is the difficulty to retrieve the values of the renamed objects. This problem is referred to as state recovery problem.

Existing techniques to solve the state recovery problem have a number of disadvantages. In super-scalar architectures, the mapping between renamed registers and renaming registers is kept track of dynamically at run time. This technique requires extra hardware. In optimizing compilers, an extra store instruction or an assignment operation is inserted. This technique is not suitable when the renamed objects that become targets of many instructions. In addition, register moving instruction is a costly operation, especially for floating point registers.

In binary translation, every instruction is translated only once or in a limited number of times. Therefore, the dynamic approach used by super-scalar architectures is not necessary and may waste a lot of resources. The technique used by the optimizing compilers may not be suitable either when the renames registers become target registers of other instructions and register moving incurs additional costs in program code and processing speed.

Therefore, there is a need to have an efficient technique to provide register renaming in binary translation.

### BRIEF DESCRIPTION OF THE DRAWINGS

The features and advantages of the present invention will become apparent from the following detailed description of the present invention in which:

FIG. 1 is a diagram illustrating a system 100 in which one embodiment of the invention can be practiced.

FIG. 2 is a diagram illustrating register mappings according to one embodiment of the invention.

FIG. 3 is a flowchart illustrating a process to perform binary translation according to one embodiment of the invention.

FIG. 4 is a flowchart illustrating a process to apply a rollback according to one embodiment of the invention.

FIG. 5 is a flowchart illustrating a process to apply a recovery according to one embodiment of the invention.

### DESCRIPTION OF THE INVENTION

The present invention is a technique to improve the effectiveness of the register renaming mechanism used in binary translation. The last use of a first canonical register in a block of code is recorded after a renaming. The canonical register is mapped to an original register. Then, either a rollback or a recovery is applied to the original register depending on whether the recorded last use occurs before a last definition of original register in the block of code. If the recorded last use occurs before the last definition of the original register, then the rollback is applied to the original register. Otherwise, the first recovery is applied to the original register

The technique in the present invention achieves at least one of the following advantages: (1) synchronization of the system state can be achieved with no extra overhead with the rollback mechanism, (2) copy propagation used in renaming is enhanced by the use of last definition and last canonical use, (3) reliability of translation is achieved by the use of a recovery mechanism as a complementary way when rollback is not applicable, and (4) canonical registers may serve as renaming registers after copy instructions are met

In the following description, for purposes of explanation, numerous details are set forth in order to provide a thorough understanding of the present invention. However, it will be apparent to one skilled in the art that these specific details are not required in order to practice the present invention. In other instances, well-known structures are shown in block diagram form in order not to obscure the present invention.

The present invention may be implemented by hardware, software, firmware, microcode, or any combination thereof. When implemented in software, firmware, or microcode, the elements of the present invention are the program code or code segments to perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc. The program or code segments may be stored in a processor readable medium or transmitted by a computer data signal embodied in a carrier wave, or a signal modulated by a carrier, over a transmission medium. The “processor readable medium” may include any medium that can store or transfer information. Examples of the processor readable medium include an electronic circuit, a semiconductor memory device, a ROM, a flash memory, an erasable ROM (EROM), a floppy diskette, a compact disk (CD-ROM), an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

It is noted that the invention may be described as a process which is usually depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

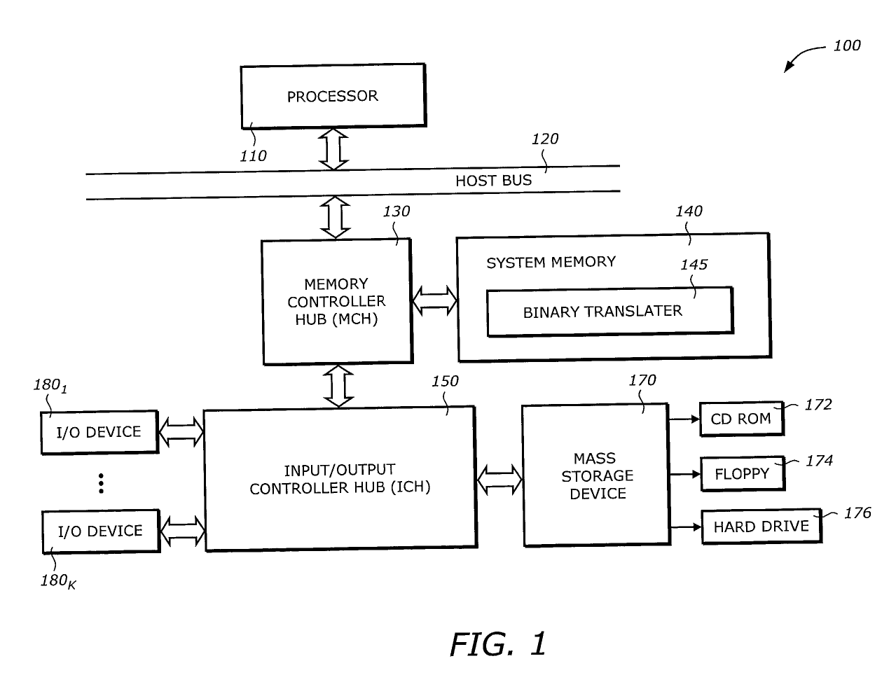

FIG. 1 is a diagram illustrating a system 100 in which one embodiment of the invention can be practiced. The system 100 includes a processor 110, a host bus 120, a memory control hub (MCH) 130, a system memory 140, an input/output control hub (ICH) 150, a mass storage device 170, and input/output devices 180₁ to 180_{K.}.

The processor 110 represents a central processing unit of any type of architecture, such as embedded processors, micro-controllers, digital signal processors, super-scalar computers, vector processors, single instruction multiple data (SIMD) computers, complex instruction set computers (CISC), reduced instruction set computers (RISC), very long instruction word (VLIW), or hybrid architecture.

The host bus 120 provides interface signals to allow the processor 110 to communicate with other processors or devices, e.g., the MCH 130. The host bus 120 may support a uni-processor or multiprocessor configuration. The host bus 120 may be parallel, sequential, pipelined, asynchronous, synchronous, or any combination thereof.

The MCH 130 provides control and configuration of memory and input/output devices such as the system memory 140 and the ICH 150. The MCH 130 may be integrated into a chipset that integrates multiple functionalities such as the isolated execution mode, host-to-peripheral bus interface, memory control. For clarity, not all the peripheral buses are shown. It is contemplated that the system 100 may also include peripheral buses such as Peripheral Component Interconnect (PCI), accelerated graphics port (AGP), Industry Standard Architecture (ISA) bus, and Universal Serial Bus (USB), etc.

The system memory 140 stores system code and data. The system memory 140 is typically implemented with dynamic random access memory (DRAM) or static random access memory (SRAM). The system memory 140 may include program code or code segments implementing one embodiment of the invention. The system memory 140 includes a binary translator 145. The system memory 140 may also include other programs or data which are not shown, such as an operating system.

The ICH 150 has a number of functionalities that are designed to support I/O functions. The ICH 150 may also be integrated into a chipset together or separate from the MCH 130 to perform I/O functions. The ICH 150 may include a number of interface and I/O functions such as PCI bus interface, processor interface, interrupt controller, direct memory access (DMA) controller, power management logic, timer, universal serial bus (USB) interface, mass storage interface, low pin count (LPC) interface, etc.

The mass storage device 170 stores archive information such as code, programs, files, data, applications, and operating systems. The mass storage device 170 may include compact disk (CD) ROM 172, floppy diskettes 174, and hard drive 176, and any other magnetic or optic storage devices. The mass storage device 170 provides a mechanism to read machine-readable media. In particular, the machine-readable media may be a computer program product that includes a machine useable medium which embeds program code to perform tasks in the binary translator 145. The program code embedded in the machine-readable media is loaded from the mass storage device to the system memory 140 and become the binary translator 145. For example, as will be described later, the program code include computer readable program code to record a first last use of a first canonical register in a block of code after a renaming, and computer readable program code to apply one of a first rollback and a first recovery to the first original register based on whether the recorded first last use occurs before a first last definition of the first original register in the block of code. The above program code, when executed, causes the processor 110 to perform the above tasks such as recording the last use of a canonical register and applying one of the rollback and recovery.

The I/O devices 180₁ to 180_{K} may include any I/O devices to perform I/O functions. Examples of I/O devices 180₁ to 180_{K} include controller for input devices (e.g., keyboard, mouse, trackball, pointing device), media card (e.g., audio, video, graphics), and a network device and any other peripheral controllers.

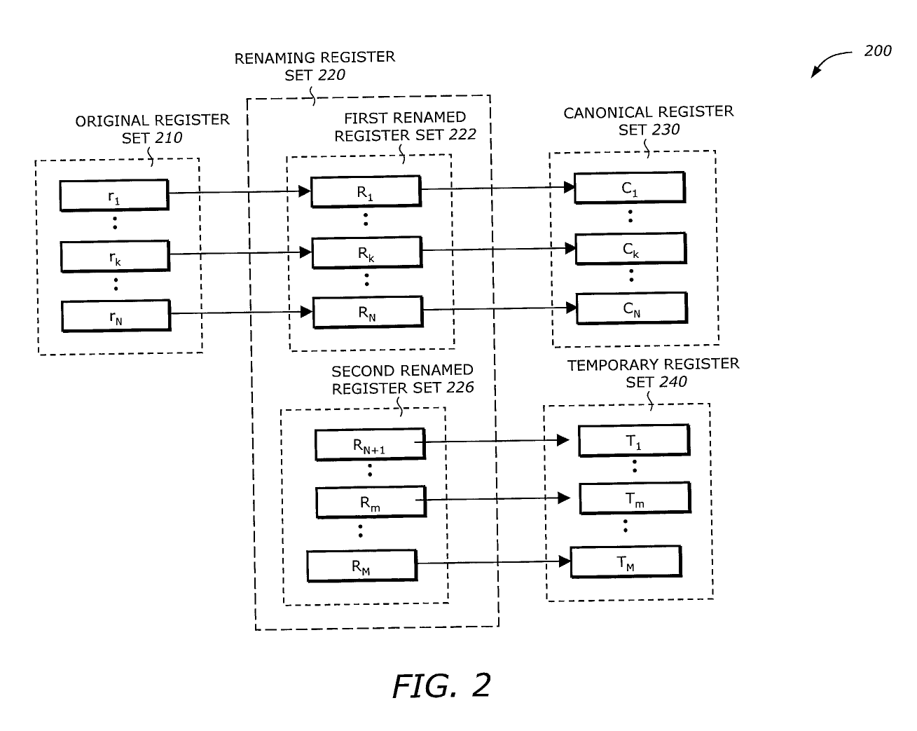

FIG. 2 is a diagram illustrating a register mapping 200 according to one embodiment of the invention. The register mapping 200 includes an original register set 210, a renaming register set 220, a canonical register set 230, and a temporary register set 240.

The original register set 210 includes N original registers r₁ to r_{N}. These original registers r₁ to r_{N} are the architectural registers of the processor 100 or a source processor that the original code runs on. The original registers r₁ to r_{N} may be a register file used by the instruction set architecture (ISA) for the underlying processor. In one embodiment, the registers r₁ to r_{N} are the floating point (FP) registers used in the IA-32 or IA-64 processors. The original register set 210 represents the source registers.

The renaming register set 220 includes registers used in the target processor that the translated code will run on. Typically the number of registers in the renaming register set 220 is larger than the number of the registers in the original register set 210. Let M be the number of registers in the renaming register set 220. Typically, M>N. The renaming register set 220 is divided into two sets: a first renaming register set 222 and a second renaming register set 226. The first renaming register set 222 includes N registers R₁ to R_{N} corresponding to the N original registers r₁ to r_{N}, respectively. The second renaming register set 226 includes M−N registers R_{N+1} to R_{M}. These are the temporary registers.

The canonical register set 230 includes N canonical registers C₁ to C_{N} mapped to the N original registers r₁ to r_{N}, respectively. This mapping facilitates the state recovery problem because the values of an original register rᵢ can be simply obtained from its corresponding canonical register C₁.

The temporary register set 240 includes M-N temporary registers T_{N+1} to T_{M}. These registers are mapped from the second renaming registers R_{N+1} to R_{M}, respectively. These registers may be used to store temporary variables during the renaming process. Since M is typically much larger than N, there are many unused temporary registers in the temporary register set 240 that may be used for some processes in this invention.

To solve the state recovery problem, at the end of a block of code, it is desired that the canonical registers C₁, C₂, . . . , C_{N} contain the right values. Then the values of the original registers r₁ to r_{N} can be obtained from the canonical registers C₁ to C_{N}. The state recovery problem is to recover the values of the canonical registers C₁ to C_{N} at the end of the block of code.

The state recovery problem is efficiently solved by using a rollback and a recovery mechanism. In basic blocks, all writes to registers are definite. It is simple to identify which write is the last definition to a given register r₁ in a given block. Suppose that after renaming, the translated target of the last definition to rᵢ becomes Rⱼ. The rollback mechanism can be applied as follows:

i. Replace the last write to Rⱼ with Cᵢ.

ii. Replace all the references to Rⱼ with Cᵢ after the last write of Rⱼ

Compared with the optimizing compiler, the extra code Cᵢ←Rⱼ is omitted.

Although rollback can generate efficient translated code, it may not be applied all the time directly because there are cases that rollback may lead to incorrect code as will be explained later. To determine if rollback can be safely applied, the following determination is made.

The last definition to register rᵢ in a block is recorded. Then, the last canonical use of the canonical register C₁ is also recorded after renaming. The last canonical use of Cᵢ is the last reference of Cᵢ in the block after renaming and before rollback. If the last use of the canonical register Cᵢ is before the last definition of rᵢ, then rollback can be safely applied. Otherwise, a recovery mechanism is applied.

Suppose rᵢ is renamed to Rⱼ. A recovery mechanism inserts a copy instruction Cᵢ←Rⱼ at the end of the block to let Cᵢ hold the correct value from the renaming register Rj. To ensure correct copying, a temporary register is used. The reason for this can be explained in the following example. Suppose rᵢ is renamed as Cⱼ, and rⱼ is renamed as Cᵢ. Applying the recovery mechanism as a simple copying as above may lead to the following incorrect code:

iii. C₁←Cⱼ

iv. C_{J}←Cᵢ

In the above example, Cⱼ cannot get the correct value because Cᵢ has been overwritten in the previous recovery code. To solve this problem, R_{J} is first copied to an unused temporary register Tₖ, and then Tₖ is copied to Cᵢ later as follows:

v. Tₖ←Rⱼ

vi. . . .

vii. C₁←Tₖ

This way can also take advantage of the VLIW architecture. The copy instructions from the renaming register R's to the temporary registers T's are executed first. Then, other instructions are executed next. The first group of instructions can be executed in parallel, or in pipeline, and the second group can also be executed in parallel, or in pipeline. Execution time can therefore be optimized.

The recovery code in the above example becomes:

viii. Tₖ←Cⱼ

ix. Tₛ←Cᵢ

x. Cⱼ←Tₖ

xi. Cᵢ←Tₛ

The following example illustrates the rollback and recovery mechanisms. In the following example, the left side is the pseudo source code and the right side is the translated code after renaming.

| xii. Source code | | | | Translated code | | |
|---|---|---|---|---|---|---|
| b. | 1 | fld | r1 = mem[b] | (1) | ldf | T1 = mem[b] |
| c. | 2 | fmov | r2 = r7 | (2) | | |
| d. | 3 | fmul | r7 = r7, r2 | (3) | mulf | T2 = C7, C7 |
| e. | 4 | fadd | r2 = r7, r2 | (4) | addf | T3 = T2, C7 |

Here, fld, finov, fmul, and fadd are load, register move, FP multiplication, and FP addition instructions in the source architecture. Ldf, mulf, addf, and movf are load, FP multiplication, FP addition, and register moving instructions in the target architecture.

If rollback is applied directly without considering the last definition and the last use, the translated code will become incorrect as follows because the C7 read in the fourth instruction is overwritten by the third instruction.

| i. Source code | | | | Translated code | | |
|---|---|---|---|---|---|---|
| f. | 1 | fld | r1 = mem[b] | (1) | ldf | C1 = mem[b] |
| g. | 2 | fmov | r2 = r7 | (2) | | |
| h. | 3 | fmul | r7 = r7, r2 | (3) | mulf | C7 = C7, C7 |
| i. | 4 | fadd | r2 = r7, r2 | (4) | addf | C2 = C2, C7 |

The last canonical use of C7 is the instruction 4. There are no last canonical uses for other registers. Using the above rule, rollback is applied to register r1 and r2, and recovery is applied for register r7. The final translated code after rollback and recovery is correct as follows.

| i. Source code | | | | Translated code | | |
|---|---|---|---|---|---|---|
| j. | 1 | fld | r1 = mem[b] | (1) | ldf | C1 = mem[b] |
| k. | 2 | fmov | r2 = r7 | (2) | | |
| l. | 3 | fmul | r7 = r7, r2 | (3) | mulf | T2 = C7, C7 |
| m. | 4 | fadd | r2 = r7, r2 | (4) | addf | C2 = T2, C7 |
| | | | | (5) | movf | C7 = T2 |

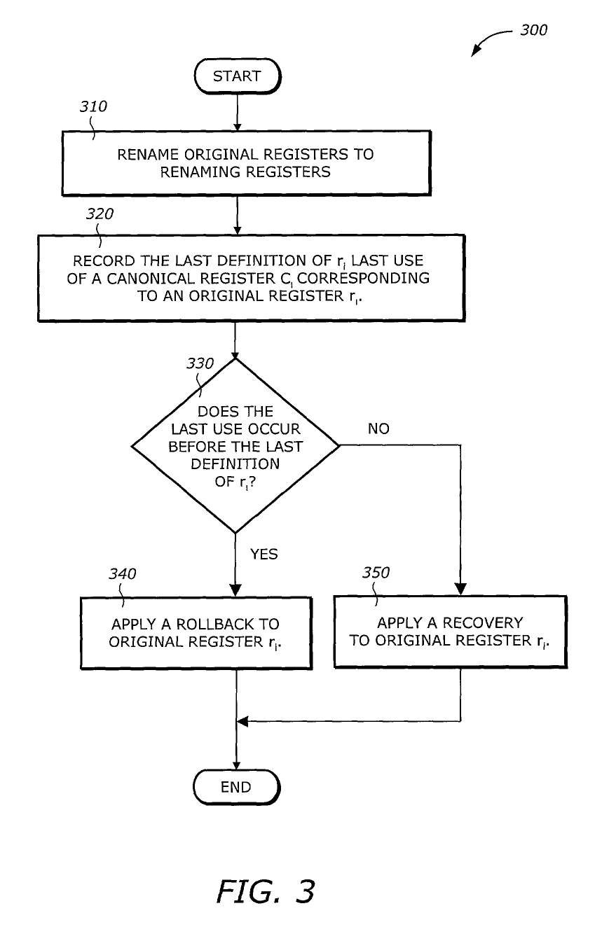

FIG. 3 is a flowchart illustrating a process 300 to perform binary translation according to one embodiment of the invention.

Upon START, the process 300 renames the original registers to renaming registers (Block 310). In the renaming process, copy propagation and constant propagation are performed in a conventional way. Then, the process 300 records the last definition of the original register rᵢ and the last use of the corresponding canonical register C, (Block 320).

Next, the process 300 determines if the last use of the canonical register Cᵢ occur before the last definition of the original register rᵢ (Block 330). If so, the process 300 applies a rollback to the original register rᵢ (Block 340) and is then terminated. Otherwise, the process 300 applies a rollback to original register r, (Block 350) and is then terminated.

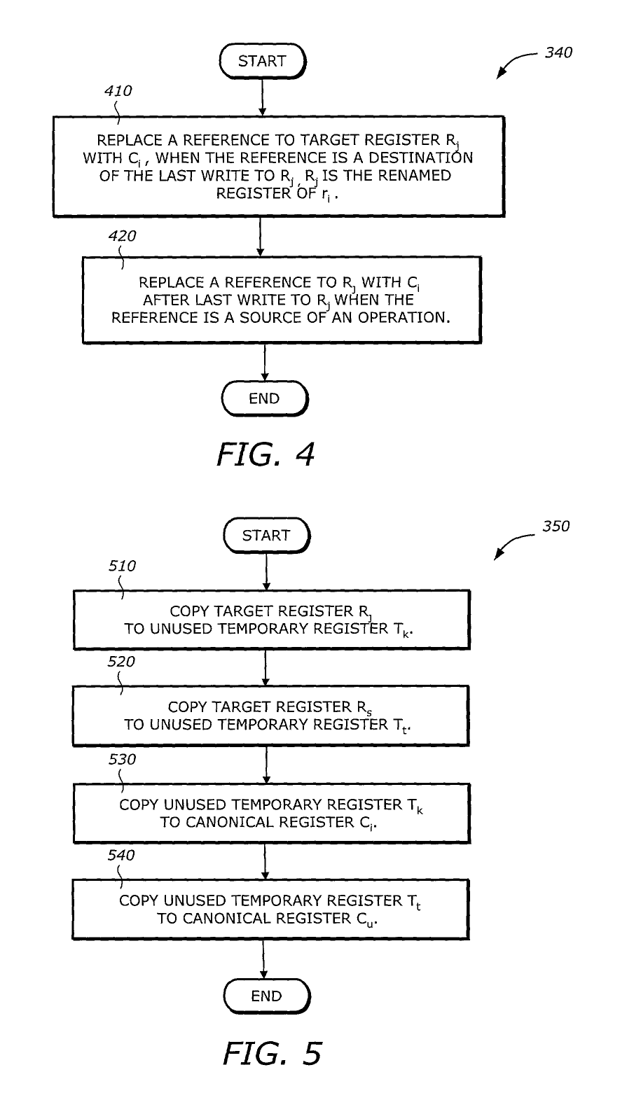

FIG. 4 is a flowchart illustrating the process 340 to apply a rollback according to one embodiment of the invention.

Upon START, the process 340 replaces a reference to the target register Rⱼ with C₁ when the reference is a destination of the last write to Rⱼ in the block (Block 410). Rⱼ is the renamed register of the original register. Then, the process 340 replace a reference to the renamed register Rⱼ with Cᵢ after the last write to Rⱼ when the reference is a source of an operation (Block 420). The process 340 is then terminated.

FIG. 5 is a flowchart illustrating the process 350 to apply a recovery according to one embodiment of the invention.

Upon START, the process 350 copies target register R_{J} to an unused temporary register Tₖ (Block 510). Then, if there is another target register Rₛ, the process 350 copies the target Rₛ to another unused temporary register Tₜ (Block 520). Then, the process 350 copies the unused temporary register Tₖ to the canonical register Cᵢ (Block 530). Next, the process 350 copies the unused temporary register Tₜ to the canonical register Cᵤ (Block 540). The canonical register Cᵤ corresponds to the original register rᵤ that gives rise to the target register Rₛ. Then the process 350 is terminated.

The technique can be described in the following pseudocode:

for each source register ri

| | |
|---|---|
| { | if (the last definition of ri is before the last canonical use of Ci) { |

| | |
|---|---|
| 1. | Set ri needs recovery |
| 2. | Clear the last definitions of ri |

| | |
|---|---|
| ii. | } |

| | |
|---|---|
| n. | } |
| o. | Set a NOP instruction as the last instruction in the block |
| p. | Set Insert_1, Insert_2 as the last instructions in the block |
| q. | Set Insert_3 as 0 |
| r. | for each source register rx which needs recovery |
| s. | { |

| | |
|---|---|
| i. | if (its renaming register is a canonical register Cy && x!= y) { |

| | |
|---|---|
| 1. | if (the renaming register of ry is a temporary register Tn) { |

| | |
|---|---|
| a. | generate copy instruction Cx ← Cy |
| b. | insert it after Insert_1 |
| c. | adjust Insert_1 to this copy instruction |

| | |
|---|---|
| 2. | } |
| 3. | else if (the renaming register of ry is a canonical register Cz && z!=y) { |

| | |
|---|---|
| a. | get a scratch register Tx |
| b. | generate copy instruction Tx ← Cy |
| c. | insert it before Insert_2 |
| d. | generate another copy instruction Cx ← Tx |
| e. | if (Insert_3 is 0) |

| | |
|---|---|
| i. | Insert_3 = Insert 1 |

| | |
|---|---|
| f. | insert the copy instruction after Insert_3 |
| g. | adjust Insert_3 to this instruction |

| | |
|---|---|
| 4. | } |

| | |
|---|---|
| ii. | } |

| | |
|---|---|
| t. | } |
| u. | for each source register rx which needs recovery |
| v. | { |

| | |
|---|---|
| i. | if (its renaming register is a temporary register Ty) { |

| | |
|---|---|
| 1. | generate a copy instruction Cx ← Ty |
| 2. | insert it after Insert_1 |
| 3. | adjust the Insert_1 to this copy instruction |

| | |
|---|---|
| ii. | } |

| | |
|---|---|
| w. | } |
| x. | for each non-canonical register Ty |

| | |
|---|---|
| i. | set Replace[y] = 0 |

| | |
|---|---|
| y. | find the source register rx whose last definition Ilx is the nearest one to the beginning of the |
| | block |
| z. | set Replace[x] = Cx |
| aa. | Scan each IL from Ilx to the end of the block |
| bb. | { |

| | |
|---|---|
| i. | for each source operand in IL { |

| | |
|---|---|
| 1. | if (it is a temporary register Ty && Replace[y] ! = 0) |

| | |
|---|---|
| a. | Replace Ty by Replace[y] |

| | |
|---|---|
| ii. | } |
| iii. | if (IL is a last definition of rz) { |

| | |
|---|---|
| 1. | find the renaming temporary register of rz: Tn |
| 2. | set Replace[n] = Cz |
| 3. | replace the definition in the IL with Cz |

| | |
|---|---|
| iv. | } |

| | |
|---|---|
| cc. | } |

While this invention has been described with reference to illustrative embodiments, this description is not intended to be construed in a limiting sense. Various modifications of the illustrative embodiments, as well as other embodiments of the invention, which are apparent to persons skilled in the art to which the invention pertains are deemed to lie within the spirit and scope of the invention.

What is claimed is:

1. A method comprising:
recording a first last use of a first canonical register in a block of code after a renaming, the first canonical register being mapped to a first original register; and
applying one of a first rollback and a first recovery to the first original register based on whether the recorded first last use occurs before a first last definition of the first original register in the block of code.

2. The method of claim 1 wherein applying one of the first rollback and the first recovery comprises:
applying the first rollback to the first original register if the recorded first last use occurs before the first last definition of the first original register; and
applying the first recovery to the first original register if the recorded first last use does not occur before the first last definition of the first original register.

3. The method of claim 2 wherein applying the first rollback comprises:
replacing a first reference to a first target register with the first canonical register when the first reference is a destination of a first last write to the first target register, the first target register corresponding to the first original register after the renaming; and
replacing a second reference to the first target register with the first canonical register when the second reference is a source of a first operation after the first last write to the first target register.

4. The method of claim 2 wherein applying the first recovery comprises:
copying the first target register to the first canonical register at end of the block.

5. The method of claim 4 wherein copying the first target register comprises:
copying the first target register to a first unused temporary register; and
copying the first unused temporary register to the first canonical register.

6. The method of claim 5 further comprises:
recording a second last use of a second canonical register in the block of code after the renaming, the second canonical register being mapped to a second original register; and
applying one of a second rollback and a second recovery to the second original register based on whether the recorded second last use of the second canonical register occurs before a second last definition of the second original register in the block of code.

7. The method of claim 6 wherein applying one of the second rollback and the second recovery comprises:
applying the second rollback to the second original register if the recorded second last use occurs before the second last definition of the second original register; and
applying the second recovery to the second original register if the recorded second last use does not occur before the second last definition of the second original register.

8. The method of claim 7 wherein applying the second rollback comprises:
replacing a third reference to a second target register with the second canonical register when the third reference is a destination of a second last write to the second target register, the second target register corresponding to the second original register after the renaming; and
replacing a fourth reference to the second target register with the second canonical register when the fourth reference is a source of a second operation after the second last write to the second target register.

9. The method of claim 8 wherein applying the second recovery comprises:
copying the second target register to the second canonical register at end of the block.

10. The method of claim 9 wherein copying the second target register comprises:
copying the second target register to a second unused temporary register before copying the first unused temporary register to the first canonical register; and
copying the second unused temporary register to the second canonical register.

11. A computer program product comprising:
a machine useable medium having program code embedded therein, the program code comprising:
computer readable program code to record a first last use of a first canonical register in a block of code after a renaming, the first canonical register being mapped to a first original register; and
computer readable program code to apply one of a first rollback and a first recovery to the first original register based on whether the recorded first last use occurs before a first last definition of the first original register in the block of code.

12. The computer program product of claim 11 wherein the computer readable program code to apply one of the first rollback and the first recovery comprises:
computer readable program code to apply the first rollback to the first original register if the recorded first last use occurs before the first last definition of the first original register; and
computer readable program code to apply the first recovery to the first original register if the recorded first last use does not occur before the first last definition of the first original register.

13. The computer program product of claim 12 wherein the computer readable program code to apply the first rollback comprises:
computer readable program code to replace a first reference to a first target register with the first canonical register when the first reference is a destination of a first last write to the first target register, the first target register corresponding to the first original register after the renaming; and
computer readable program code to replace a second reference to the first target register with the first canonical register when the second reference is a source of a first operation after the first last write to the first target register.

14. The computer program product of claim 12 wherein the computer readable program code to apply the first recovery comprises:
computer readable program code to copy the first target register to the first canonical register at end of the block.

15. The computer program product of claim 14 wherein the computer readable program code to copy the first target register comprises:
computer readable program code to copy the first target register to a first unused temporary register; and
computer readable program code to copy the first unused temporary register to the first canonical register.

16. The computer program product of claim 15 further comprises:
computer readable program code to record a second last use of a second canonical register in the block of code after the renaming, the second canonical register being mapped to a second original register; and
computer readable program code to apply one of a second rollback and a second recovery to the second original register based on whether the recorded second last use of the second canonical register occurs before a second last definition of the second original register in the block of code.

17. The computer program product of claim 16 wherein the computer readable program code to apply one of the second rollback and the second recovery comprises:
computer readable program code to apply the second rollback to the second original register if the recorded second last use occurs before the second last definition of the second original register; and
computer readable program code to apply the second recovery to the second original register if the recorded second last use does not occur before the second last definition of the second original register.

18. The computer program product of claim 17 wherein the computer readable program code to apply the second rollback comprises:
computer readable program code to replace a third reference to a second target register with the second canonical register when the third reference is a destination of a second last write to the second target register, the second target register corresponding to the second original register after the renaming; and
computer readable program code to replace a fourth reference to the second target register with the second canonical register when the fourth reference is a source of a second operation after the second last write to the second target register.

19. The computer program product of claim 18 wherein the computer readable program code to apply the second recovery comprises:
computer readable program code to copy the second target register to the second canonical register at end of the block.

20. The computer program product of claim 19 wherein the computer readable program code to copy the second target register comprises:
computer readable program code to copy the second target register to a second unused temporary register before copying the first unused temporary register to the first canonical register; and
computer readable program code to copy the second unused temporary register to the second canonical register.

21. A system comprising:
a processor; and
a memory coupled to the processor to store program code, the program code, when executed, causing the processor to:
record a first last use of a first canonical register in a block of code after a renaming, the first canonical register being mapped to a first original register; and
apply one of a first rollback and a first recovery to the first original register based on whether the recorded first last use occurs before a first last definition of the first original register in the block of code.

22. The system of claim 21 wherein the program code causing the processor to apply one of the first rollback and the first recovery causes the processor to:
apply the first rollback to the first original register if the recorded first last use occurs before the first last definition of the first original register; and
apply the first recovery to the first original register if the recorded first last use does not occur before the first last definition of the first original register.

23. The system of claim 22 wherein the program code causing the processor to apply the first rollback causes the processor to:
replace a first reference to a first target register with the first canonical register when the first reference is a destination of a first last write to the first target register, the first target register corresponding to the first original register after the renaming; and
replace a second reference to the first target register with the first canonical register when the second reference is a source of a first operation after the first last write to the first target register.

24. The system of claim 22 wherein the program code causing the processor to apply the first recovery causes the processor to:
copy the first target register to the first canonical register at end of the block.

25. The system of claim 24 wherein the program code causing the processor to copy the first target register causes the processor to:
copy the first target register to a first unused temporary register; and
copy the first unused temporary register to the first canonical register.

26. The system of claim 25 wherein the program code further causes the processor to:
record a second last use of a second canonical register in the block of code after the renaming, the second canonical register being mapped to a second original register; and
apply one of a second rollback and a second recovery to the second original register based on whether the recorded second last use of the second canonical register occurs before a second last definition of the second original register in the block of code.

27. The system of claim 26 wherein the program code causing the processor to apply one of the second rollback and the second recovery causes the processor to:
apply the second rollback to the second original register if the recorded second last use occurs before the second last definition of the second original register; and
apply the second recovery to the second original register if the recorded second last use does not occur before the second last definition of the second original register.

28. The system of claim 27 wherein the program code causing the processor to apply the second rollback causes the processor to:
replace a third reference to a second target register with the second canonical register when the third reference is a destination of a second last write to the second target register, the second target register corresponding to the second original register after the renaming; and
replace a fourth reference to the second target register with the second canonical register when the fourth reference is a source of a second operation after the second last write to the second target register.

29. The system of claim 28 wherein the program code causing the processor to apply the second recovery causes the processor to:
copy the second target register to the second canonical register at end of the block.

30. The system of claim 29 wherein the program code causing the processor to copy the second target register causes the processor to:
copy the second target register to a second unused temporary register before copying t he first unused temporary register to the first canonical register; and
copy the second unused temporary register to the second canonical register.
